(19) United States
(12) Patent Application Publication
(10) Pub. No.: US 2009/0126525 A1
(43) Pub. Date: May 21, 2009

(54) Apparatus and method for supporting a substrate at a position with high precision

(75) Inventors: Katrin Pietsch, Solms (DE); Klaus-Dieter Adam, Jena (DE); Tillmann Ehrenberg, Schoeffengrund (DE)

Correspondence Address: SIMPSON & SIMPSON, PLLC, 5555 MAIN STREET, WILLIAMSVILLE, NY, 14221-5406, US

(73) Assignee: Vistec Semiconductor Systems GmbH, Weilburg (DE)

(21) Appl. No.: 12/286,465

(22) Filed: Sep. 30, 2008

(30) Foreign Application Priority Data
Nov. 15, 2007 (DE) 10 2007 000 990.0

(51) Int. Cl. G12B 5/00; B65G 49/07; G05G 11/00

(52) U.S. Cl. 74/490.09; 74/490.12

(57) ABSTRACT

An apparatus and a method are disclosed for supporting a substrate at a position with high precision. The substrate is placed on a stage which is configured to be traversable in a plane in two spatial directions oriented perpendicular to each other. The substrate is supported on three point-like support elements. At least one of the support elements is configured to be moveable in the plane.

### CROSS REFERENCE TO RELATED APPLICATIONS

This patent application claims priority of German Patent Application No. 10 2007 000 990.0, filed on Nov. 15, 2007, which application is incorporated herein by reference.

### FIELD OF THE INVENTION

The present invention relates to an apparatus for supporting a substrate at a position with high precision. The substrate is placed in a stage which is configured to be traversable in a plane in two spatial directions oriented perpendicular to one another. The substrate is supported on three point-like support elements.

Further, the present invention relates to a method for supporting a substrate at a position with high precision. The substrate is supported on three point-like support elements.

### BACKGROUND OF THE INVENTION

A coordinate measuring apparatus is well known from the state of the art. For example, reference is made to a conference paper entitled “Pattern Placement Metrology for Mask Making” by Dr. Carola Blasing. The paper was presented at the Semicon, Education Program Conference in Geneva, Mar. 31, 1998, in which the coordinate measuring machine has been described in detail. The structure of a coordinate measuring machine such as it is known, for example, from the state of the art, will be described in more detail below in the description with reference to FIG. 1. A method and a measuring apparatus for position determination of structures on a substrate is known from the publication of German patent application DE 100 47 211 A1. For details of the above-mentioned position determination, explicit reference is made to this document.

German patent application DE 199 49 005 discloses an apparatus and a method for inserting various substrates in a high-precision measuring apparatus. The apparatus comprises a cartridge, in which a plurality of slots are formed, in which substrate holders can be inserted for various substrates. Further, a loading station is provided, in which the substrate holder can be loaded with a substrate suitable for the substrate holder. An automatic transfer means places the substrate holder together with the substrate on the measuring stage. It is not checked, however, whether the substrate holder is precisely positioned on the measuring stage. Further, it is not checked whether the substrate itself is properly positioned in the substrate holder.

German Patent Specification DE 199 49 008 discloses an apparatus and method for loading substrates of various sizes in a substrate holder. A plurality of carrying means, which can each be used for the various substrate sizes, are arranged on a bottom plate. For loading the substrates in a substrate holder, first the substrate holder is placed on the apparatus. Then, a substrate is placed onto the carrying means suitable for this purpose. After lifting off or removing the substrate holder from the apparatus, the substrate itself comes to lie within the substrate holder. The substrate is then transferred together with the substrate holder into a measuring machine. Again, it is not possible to determine the precise position of the substrate in relation to theoretical placement points of the substrate.

### SUMMARY OF THE INVENTION

It is therefore an object of the present invention to create an apparatus which enables substrates to be placed on a stage in such a way that the substrates are supported at predetermined points of the substrate.

The above object is solved by an apparatus for supporting a substrate at a position with high precision, comprising a stage of a coordinate measuring machine, wherein the substrate is placed on said stage and said stage is configured to be traversable in a plane in two spatial directions oriented perpendicular to one another; and three point-like support elements support the substrate, wherein at least one of said support elements moveable in said plane and said point-like supports element are formed in a mirror body, which rests on said stage.

It is another object of the present invention to create a method enabling a substrate to be placed on a stage so that predetermined points of the substrate come to lie on support elements.

The above object is solved by a method for supporting a substrate at a position with high precision, wherein the substrate is supported by three point-like support elements provided in a mirror body of a coordinate measuring machine, wherein said mirror body rests on a stage, comprising the steps of:

placing the substrate in the stage traversable in a plane;

measuring the size of the substrate;

removing the substrate from the stage;

positioning one of the point-like support elements in the plane in such a way that the substrate is supported at support points defined according to its size; and

placing the substrate on the stage again after positioning the at least one point-like support element.

It is advantageous if at least one of the support elements is configured to be moveable in the plane. By means of this movement of the at least one support element it is possible to support the substrate at the predetermined points by the plurality of support elements. Since the substrate is usually placed on three support elements, it undergoes mechanical deformation due to the force of gravity, which will result in a bending effect on the substrate. In a high-precision coordinate measuring machine, this bending effect will negatively affect the measuring results with respect to the position of the structures on a substrate. To be able to correct the measuring values with respect to the bending effect it is necessary to theoretically compute the amount of bending. The amount of bending is dependent, however, on the position of the support elements in relation to the substrate. To be able to reuse the once calculated amount of bending of the substrate for a plurality of measurements of the substrate, or other measurements on other substrates of the same type, it must be ensured that the support elements support the substrate at the points provided on the substrate for this purpose. This can only be achieved by the present invention, since at least one of the support elements is configured to be moveable, so that corresponding traversal of the support element can achieve that the substrate is supported at the points provided for this purpose.

In a preferred embodiment, the point-like support elements are at the corner points of a triangle. Particularly advantageously for the theoretical calculation of the degree of bending of the substrate, the support elements are at the corner points of an isosceles triangle. It is also conceivable for the point-like support elements to be arranged at the corner points of an equilateral triangle.

Advantageously all the point-like support elements are configured to be adjustable in the plane. It is therefore possible to reliably ensure that the substrate is supported at the points provided for this purpose by adjusting the support elements.

By adjusting the support elements in the plane, it will be possible to have the substrate lie with respect to the point-like support elements in such a way that the substrate has a theoretically predetermined degree of bending. By adjusting the support elements, the substrate is supported at the defined points so that the theoretically predetermined degree of bending is achieved.

Also, an optical system is provided for determining the size of the substrate. Based on the determined size of the substrate the point-like support elements are adjusted accordingly so that the point-like support elements support the substrate at the points provided for this purpose. Particularly advantageously the apparatus is used in a coordinate measuring machine, wherein the at least one point-like support element is configured to be moveable in a mirror body. The mirror body itself lies on the stage.

It is also advantageous if the at least one point-like support element, which is configured to be moveable, is arranged in a stage of a stepper.

The method is advantageous in that it enables a substrate to be supported at a position with high precision. The substrate is directly placed on three point-like support elements. First, the substrate is inserted in a stage traversable in a plane. An optical measuring system is provided for measuring the size of the substrate. Then the substrate is removed from the stage. Based on the measurement of the size of the substrate, at least one of the point-like support elements is traversed in the plane in such a way that the substrate is supported at the support points defined with respect to its size. After the at least one point-like support element has been traversed, the substrate is placed on the stage again.

### BRIEF DESCRIPTION OF THE DRAWINGS

Exemplary embodiments of the present invention and their advantages will be described in more detail in the following with reference to the accompanying drawings, in which:

FIG. 1 schematically shows a coordinate measuring machine according to the state of the art;

FIG. 2 schematically shows an inverse structure of a coordinate measuring machine;

FIG. 3 is a schematic top view of the arrangement of a coordinate measuring machine in combination with a plurality of placement positions, which are formed as auxiliary equipment for the coordinate measuring machine;

FIG. 4 is a schematic side view of how a substrate is placed in a mirror body provided on a stage;

FIG. 5 is a schematic top view of a mirror body having three support elements formed on it, on which the substrate rests;

FIG. 6a shows a first embodiment of how the substrate is placed in a mirror body, wherein an abutment edge is provided against which the substrate to be measured is placed;

FIG. 6b shows in comparison with the view shown in FIG. 6a that at least one of the support elements has been traversed to support the substrate by means of the support elements at the points provided for this purpose;

FIG. 7a shows a schematic view of the substrate resting in the mirror body, wherein the support points of the substrate do not coincide with the support element;

FIG. 7b shows the situation where the substrate has been removed again from the mirror body;

FIG. 7c shows the situation where the support point has been traversed so that it will coincide with the support point of the substrate;

FIG. 7d shows the substrate which has again been placed on the mirror body, wherein the support point of the substrate now coincides with the support element; and,

FIG. 8 is a schematic flow chart of the method according to the present invention.

### DETAILED DESCRIPTION OF THE INVENTION

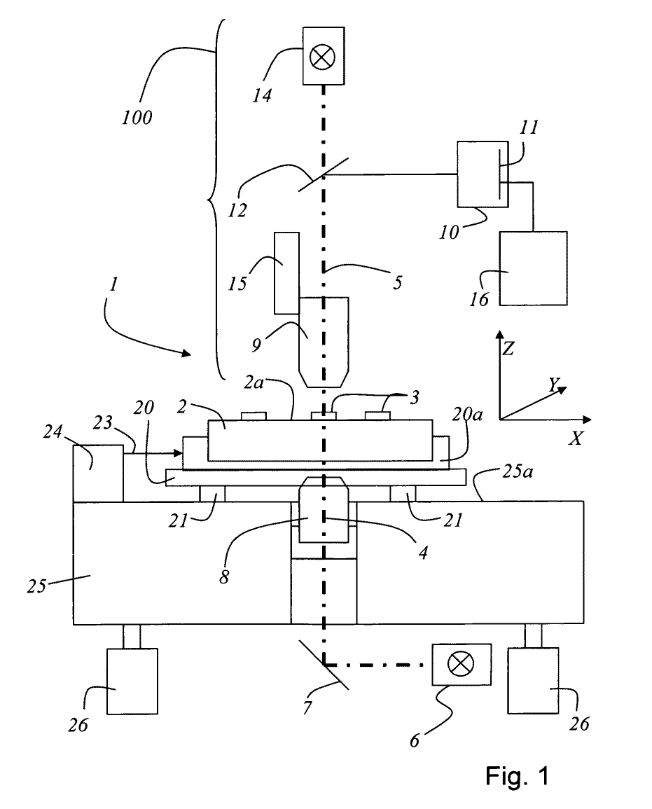

A coordinate measuring apparatus 1 of the type shown in FIG. 1 has been variously known from the prior art. For the sake of completeness, the functioning and the arrangement of the individual elements of the coordinate measuring apparatus 1 will be described. Coordinate measuring apparatus 1 comprises a measuring stage 20 arranged to be traversable in a plane 25a on bearings 21 (bearings 21 may be configured as air bearings, for example) in the X coordinate direction and the Y coordinate direction. Plane 25a is formed by an element 25. Element 25, in a preferred embodiment, is of granite. It goes without saying for a person skilled in the art, however, that element 25 may also be of a different material capable of ensuring an exact plane 25a for traversing measuring stage 20. The position of measuring stage 20 is measured by means of a laser interferometer 24, which emits a light beam 23 for measuring. For this purpose, a mirror body 20a, which also carries substrate 2 to be measured, is set on the measuring stage. The element itself is supported on vibration dampers 26 in order to isolate the measuring apparatus against building vibrations.

A substrate 2 bearing structures 3 to be measured is placed in mirror body 20a. Substrate 2 can be illuminated by means of a transmitted-light illumination means 6 and/or by an incident-light illumination means 14. The light from transmitted-light illumination means 6 passes to substrate 2 via a redirecting mirror 7 and a condenser 8. Also, light from incident-light illumination means 14 passes to substrate 2 via a measuring objective (set of lenses) 9. Measuring objective 9 is provided with an adjustment means 15 which allows measuring objective 9 to be adjusted in the Z coordinate direction. Measuring objective 9 collects the light emitted by substrate 2 and couples it out of the incident-light illumination axis 5 by means of a partially transmitting redirecting mirror 12, and directs it onto a camera 10 provided with a detector 11. Detector 11 is connected with a computer system 16 which generates digital images from the measuring values obtained by detector 11.

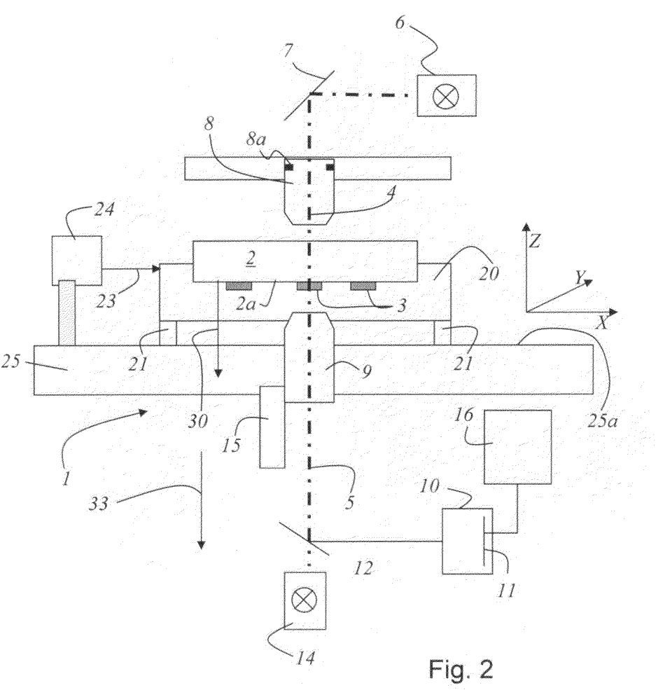

It is also conceivable for the coordinate measuring machine 1 to be configured in such a way that a mask or a substrate 2 can be inserted with the surface 2a of the mask bearing structures 3 facing in the direction of gravity. This arrangement is a so-called inverse structure of a coordinate measuring machine 1. This is advantageous in that masks 2 in the coordinate measuring machine are in the same orientation as they are in a stepper for exposure of the masks on a wafer. In this context, reference is made to FIG. 2, which describes an inverse structure in detail.

The same reference numerals will be used for the description of FIG. 2 as have been used for the components of FIG. 1. FIG. 2 shows coordinate measuring machine 1 having an inverse structure. Substrate 2 bearing a plurality of structures 3 on one surface 2a thereof is placed in a measuring stage 20. The position of measuring stage 20 is also measured by means of a laser beam 23 emitted by a laser interferometer 24. Illuminating light for the transmitted-light illumination of substrate 2 can be coupled in via an illumination means 6, via a redirecting mirror 7 or a light guide, as the case may be. The illumination light propagates along illumination beam path 4 coinciding with the optical axis of at least one measuring objective 9. Measuring objective 9 is arranged facing structures 3 on substrate 2. Illumination means 14 is provided for incident-light illumination of structures 3. The terms “substrate” and “mask” for semiconductor manufacture will be used as synonyms.

Substrate 2 is held in coordinate measuring machine 1 in such a way that surface 2a bearing structures 3 faces in the direction of the force of gravity 30 during measurement of the position of structures 3 or during the determination of structural widths of structures 3. In other words, a normal vector 30 extending from the surface bearing structures 3 is essentially parallel to vector 33 of the force of gravity.

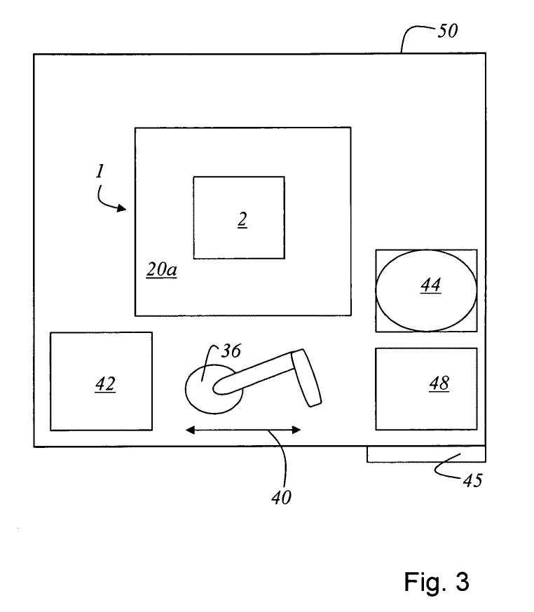

FIG. 3 shows a schematic top view of the system for determining positions of structures on a substrate or a mask 2. The arrangement of the individual components of the system within housing 50 is shown. Coordinate measuring apparatus 1 is only schematically shown by indicating measuring stage 20 (traversable in the X coordinate direction and the Y coordinate direction) and substrate 2 positioned on mirror body 20a. Within housing 50, which is configured as a climate chamber, a cartridge 42 can be arranged, for example, in which substrates 2 to be measured can be placed, for example, for tempering. Substrates 2 (masks for semiconductor manufacture), which have already been measured, may also be placed in cartridge 42, before they are discharged via a loading port 45. Loading port 45 is associated with a loading station 48 via which substrates 2 can be introduced into the system or housing 50. Between loading station 48, cartridge 42 and coordinate measuring machine 1, a transport arrangement 46 is arranged for movement along double arrow 40. Transport arrangement 46 also serves to transfer substrates 2 to the individual stations, or elements, within housing 50. It goes without saying for a person skilled in the art that the loading port for substrates 2 is formed to be closable. Transport arrangement 46 also serves, of course, to place substrates 2 on measuring stage 20 or mirror body 20a.

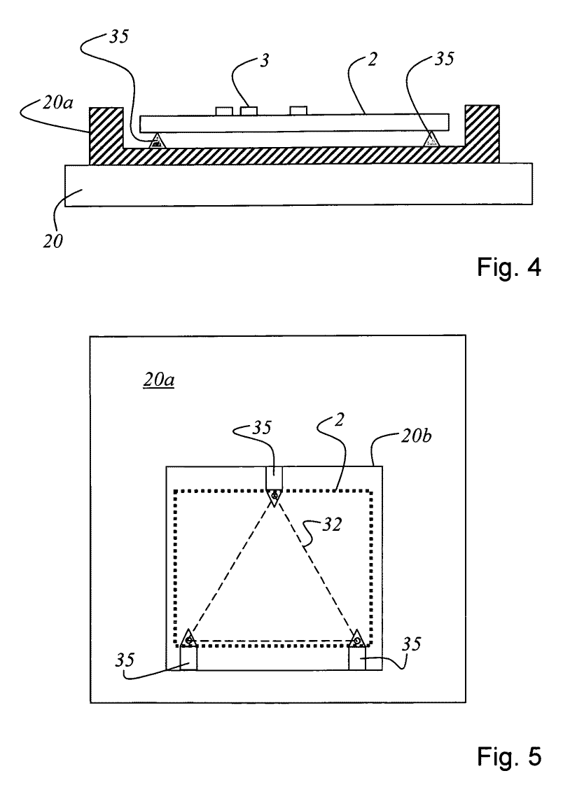

FIG. 4 is a schematic view of mirror body 20a arranged on measuring stage 20. A plurality of support elements 35, on which substrate 2 to be measured rests, are provided in the mirror body. Support elements 35 are arranged in the embodiment shown here in such a way, that they touch that surface of substrate 2 which does not bear any structures 3. Support elements 35 for the substrate are formed in such a way that they touch substrate 2 in a point-like manner. Usually ruby balls are used as support elements 35 so that the substrate contacts the ball at just one point.

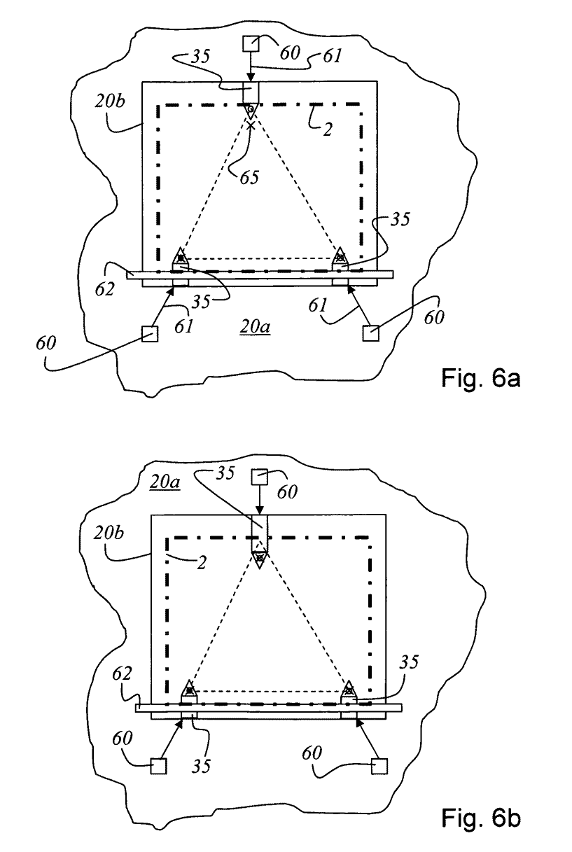

FIG. 5 is a schematic top view of mirror body 20a in which substrate 2 is supported by means of three support elements 35. In the embodiment shown here, the three support elements 35 are arranged at the corner points of a triangle. Usually mirror body 20a has a recess 20b formed in it, in which substrate 2 is placed.

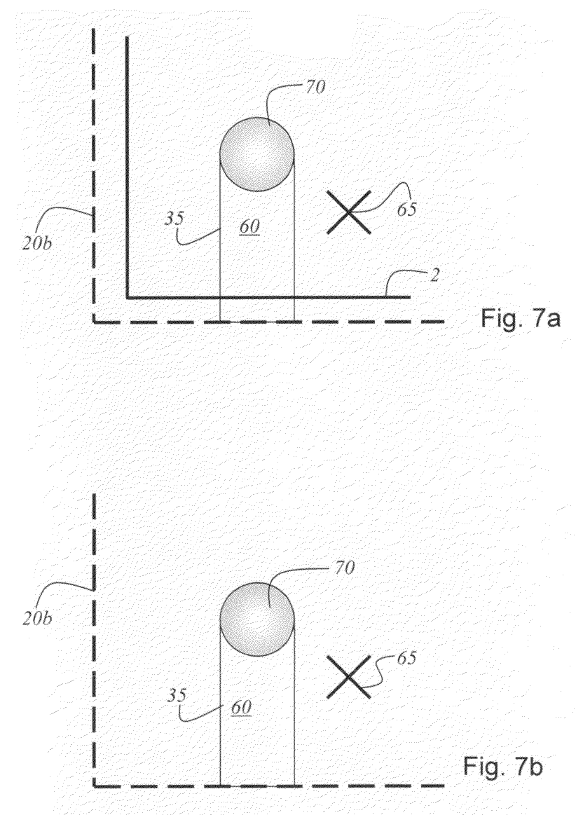

FIG. 6a is a schematic view wherein the substrate is placed in recess 20b of mirror body 20a. In the embodiment shown here, substrate 2 already abuts against abutment edge 62. This abutment edge 62 serves to furnish a preliminary orientation when positioning substrate 2 in recess 20b. Three support elements 35 on which substrate 2 rests are shown here in recess 20b. Substrate 2 is shown by a bold dot-dashed line. Each of support elements 35 is connected with a drive unit 60 so that the support elements are traversable in the direction of arrows 61. It goes without saying for a person skilled in the art that the direction of the arrows shown in FIG. 6a is only one possible embodiment. It is clear that support elements 35 can be traversed in any required direction in the X/Y plane. As shown in FIG. 6a, substrate 2 does not contact support element 35 with a support point 65. FIG. 6b shows the situation where top support element 35 has been traversed by means of driving unit 60 so that support element 35 now coincides with support point 65. The substrate thus contacts support element 35 with support points 65 provided for this purpose.

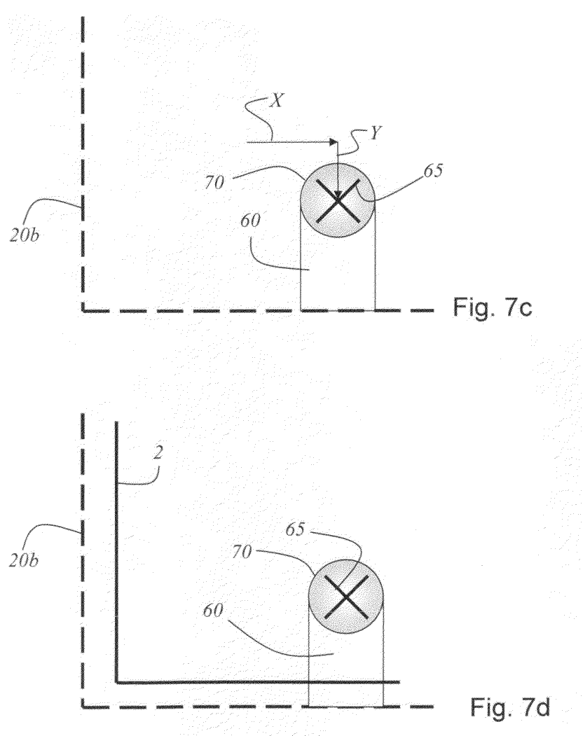

FIG. 7a shows a situation where a substrate 2 has been placed into recess 20b of mirror body 20a. Support element 35 consists of drive unit 60 and a ruby ball 70 arranged at the free end of the drive unit, the ruby ball presenting a point-like support for substrate 2. As can be seen from FIG. 7a, support point 65 of substrate 2 does not coincide with ruby ball 70 of support element 35. This results in a different bending effect of substrate 2 than has been theoretically calculated for the case where ruby balls 70 of support elements 35 coincide with all support points 65 of substrate 2. The substrate is measured, as already mentioned above, by means of an optical measuring system 100. The size of substrate 2, and therefore also the position of support points 65 of the substrate, can be derived from the measurement result. Usually, the positions of support points 65 for each substrate are stored in a database. Once the size of substrate 2 has been determined, the data are retrieved from the database. FIG. 7b shows the situation where substrate 2 has been removed from mirror body 20a. Substrate 2 is removed from the mirror body if at least one support element 35, or ruby ball 70 of the at least one support element 35, does not coincide with its support point 65. FIG. 7c shows the situation where support element 35 has been traversed in the X and Y coordinate directions in such a way that there is a coincidence of the position of support point 65 and the position of ruby ball 70 of support element 35. The path of traversal is realized by means of drive element 60. FIG. 7d shows the situation where substrate 2 has been placed again in recess 20b of mirror body 20a after support element 35 has been traversed. The coincidence of the position of support point 65 and ruby ball 70 can now be seen. The previously calculated theoretical bending effect on the substrate can now be expected.

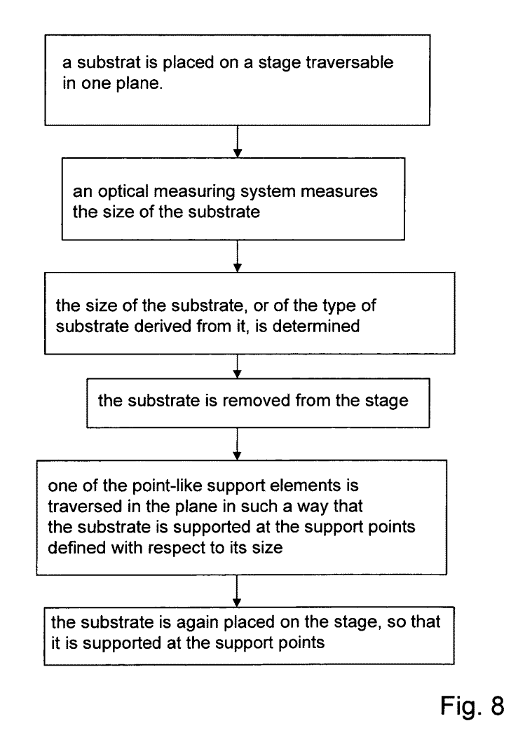

FIG. 8 is a schematic view of a flow chart of the method according to the present invention. In a first step, the substrate to be measured is placed on a stage traversable in a plane. Subsequently, the size of the substrate is measured by means of an optical measuring system. From the size of the substrate, or from the type of substrate thus derived, the support points can be calculated on which support elements 35, or ruby balls 70, make contact, so that the theoretically calculated bending effect of substrate 2 is achieved. After the size of the substrate has been determined, substrate 2 is removed again from stage 20. If it is determined that at least one of the support elements, or ruby balls 70, does not coincide with the associated support point 65 of substrate 2, support element 35 is appropriately traversed to achieve a coincidence of the positions of support element 35 and support point 65 of substrate 2. It is thus possible to have substrate 2 rest on the support points defined for its size. After traversing the point-like support elements 35, the substrate is again placed on stage 20. As already mentioned above, a computer 16 is provided for receiving the measuring data of optical system 100 and for supplying corresponding control signals to drive elements 60 of point-like support elements 35. Each of the point-like support elements 35 can therefore be individually traversed to ensure that the substrate is supported in such a way that support points 65 of substrate 2 come to coincide with ruby balls 70, or point-like support elements 35.

The invention has been described with reference to a preferred embodiment. It is conceivable, however, that changes and modifications can be made without departing from the scope of protection of the appended claims.

What is claimed is:

1. An apparatus for supporting a substrate at a position with high precision, comprising a stage of a coordinate measuring machine, wherein said substrate is placed on said stage and said stage is configured to be traversable in a plane in two spatial directions oriented perpendicular to one another; and three point-like support elements support the substrate, wherein at least one of said three point-like support elements is moveable in said plane, and said three point-like supports element are formed in a mirror body, which rests on said stage.

2. The apparatus recited in claim 1, wherein each of said three point-like support elements is arranged at a corner point of a triangle.

3. The apparatus recited in claim 2, wherein said triangle is an isosceles triangle.

4. The apparatus recited in claim 2, wherein said triangle is an equilateral triangle.

5. The apparatus recited in claim 1, wherein each of said three point-like support elements is configured to be adjustable in said plane.

6. The apparatus recited in claim 1, wherein said substrate is supported by said three point-like support elements, and said substrate has a theoretically predetermined bending effect caused by an arrangement of the three point-like support elements at predefined points on said substrate.

7. The apparatus recited in claim 1, wherein an optical system is provided for determining the size of said substrate, so that at least one of said three point-like support elements is positionable in correspondence with the size of said substrate.

8. The apparatus recited in claim 1, wherein said substrate is a mask for manufacturing a wafer.

9. A method for supporting a substrate at a position with high precision, wherein said substrate is supported by three point-like support elements provided in a mirror body of a coordinate measuring machine, wherein said mirror body rests on a stage, comprising the steps of:
placing said substrate in said stage traversable in a plane;
measuring a size of said substrate;
removing said substrate from said stage;
positioning at least one point-like support element of said three point-like support elements in said plane such that said substrate is supported at support points defined according to said size; and,
replacing said substrate on said stage.

10. The method recited in claim 9, wherein an optical system is provided for determining said size of said substrate, so that said at least one point-like support element is traversed in correspondence with said size of said substrate.

11. The method recited in claim 9, wherein said three point-like support elements are configured to be adjustable in said plane.

12. The method recited in claim 9, wherein said three point-like support elements are traversed in response to said size of said substrate such that said substrate assumes a theoretically predetermined amount of bending caused by an arrangement of said three point-like support elements at predefined points on said substrate.

13. An apparatus for supporting a substrate at a position with high precision, comprising a stage of a stepper, wherein said substrate is arranged on said stage, and said stage is configured to be traversable in a plane in two spatial directions oriented perpendicular to one another; and three point-like support elements support said substrate, and at least one of said three point-like support elements is moveable in said plane and said three point-like supports element are formed in a mirror body, which rests on said stage.
